(19) United States
(12) Patent Application Publication
(10) Pub. No.: US 2016/0234868 A1
(43) Pub. Date: Aug. 11, 2016

(54) MOBILE SECURITY MONITORING

(71) Applicants: Noor Gill, Pleasanton, CA (US); Tsai-Yu Lam, Berkeley, CA (US); Vincent Viricel, Paris (FR); Michael Zideah, Dublin, CA (US)

(72) Inventors: Noor Gill, Pleasanton, CA (US); Tsai-Yu Lam, Berkeley, CA (US); Vincent Viricel, Paris (FR); Michael Zideah, Dublin, CA (US)

(21) Appl. No.: 14/955,362

(22) Filed: Dec. 1, 2015

Related U.S. Application Data
(60) Provisional application No. 62/082,276, filed on Nov. 20, 2014.

(51) Int. Cl. H04W 76/00; H04M 1/725; H04W 4/16; H04W 76/02

(52) U.S. Cl. CPC H04W 76/002; H04W 76/026; H04M 1/72572; H04W 4/16

(57) ABSTRACT

Systems and methods are disclosed for security monitoring using a mobile device by detecting an activation condition associated with an emergency; and capturing and sending emergency data stream including images or video, audio, and positioning coordinates to a cloud-based processor to store and forward to a predetermined circle of family and friends to allow them to view the stream of audio, images/video and positioning coordinates in real time.

This application claims priority to Provisional Application 62/082,276, the content of which is incorporated by reference.

### BACKGROUND

The present invention relates to mobile security monitoring.

In emergency situations time and communication with help services is paramount. In many emergency situations it is imperative to the well being of the victim for help services to act fast, particularly in the case of fires and Community Emergencies. While many cities have established emergency response systems and teams, there are still many cities lacking in emergency response infrastructure. As a result, many emergency situations of which the severity could much lessened occur due to lack of communications with help services, inaccessibility to contact help services, or insufficient help service infrastructure.

In other emergencies it is beneficial to establish either one way or two way communications with a help service. For example, in the event of a kidnapping it would be beneficial to supply constant location data for tracking a victim in addition to providing video or audio feed of the event as it unfolds. In other situations, such as in a fire or medical situation, it is beneficial to establish two way communication, wherein the help service can provide instructions to the victim or someone with the victim, and receive feedback in order to provide better instructions until the individuals from the help service can arrive. Such feedback and communications can be the difference between life and death in many situations.

### BRIEF DESCRIPTION OF THE DRAWINGS

FIG. 1 shows a front view of an exemplary mobile security monitoring device.

FIG. 2 shows a rear view of the exemplary mobile security monitoring device.

FIGS. 3-4 show side views of the exemplary mobile security monitoring device, while

FIG. 5 shows a bottom view of the device.

FIG. 6 shows an exemplary user interface to activate an emergency mode for the device of FIG. 1.

FIG. 7 shows an exemplary display in response to the user interface of FIG. 6.

FIG. 8 shows a second exemplary display from FIG. 7.

FIG. 9 shows an exemplary low battery indication for the mobile security monitoring device.

FIG. 10 shows an exemplary security network for the device of FIG. 1

FIGS. 11-12 show exemplary user interfaces shown during an emergency.

FIG. 13 shows an exemplary process executed by the monitoring device of FIG. 1.

### DESCRIPTION

One implementation of the system includes an application (app) that is downloaded onto a mobile phone such as iOS, Android, and Blackberry smartphones. The app captures and sends images/video, audio, and GPS coordinates to the cloud and then back down to a predetermined circle of family and friends with a link via text to allow them to view the constant audio, images/video and GPS feeds in real time. The app can also send a text or call 9-1-1 in a situation where an emergency has taken place.

What is really unique about this app is that it turns off all audio output, as well as lights of any kind from the device for the purpose of giving the user the ability to hide in silence while the device is still sending the necessary information to the circles and police simultaneously. An example where this application may be used is when a babysitter being home and an intruder enters the home. The babysitter's first call to action would be to hide then once hidden, activate the app to contact all parties mentioned above without revealing her hiding spot to the intruder.

Whereas if she had sent/received a text message or a phone call, the phone would have lit up and emitted sounds as well as alerted the intruder of her location because of the sound of the phone. This app is designed to be easily and quickly activated due to the nature of the possible situation.

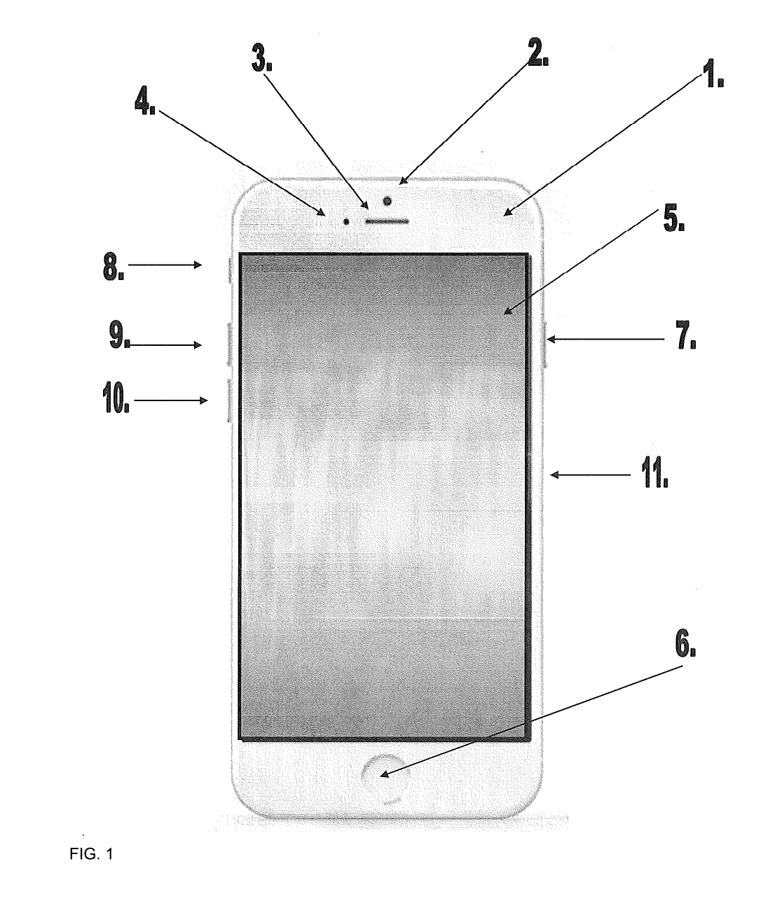

FIG. 1 shows a front view of an exemplary mobile security monitoring device, in this case Smart Phone 1 with Forward Facing Camera 2 and Ear Receiver 3, along with Front Face Microphone 4, Display/Touch Screen 5, Home Button 6, Camera Button 7, Lock Switch 8, Volume up, Button 9 and Volume Down Button 10

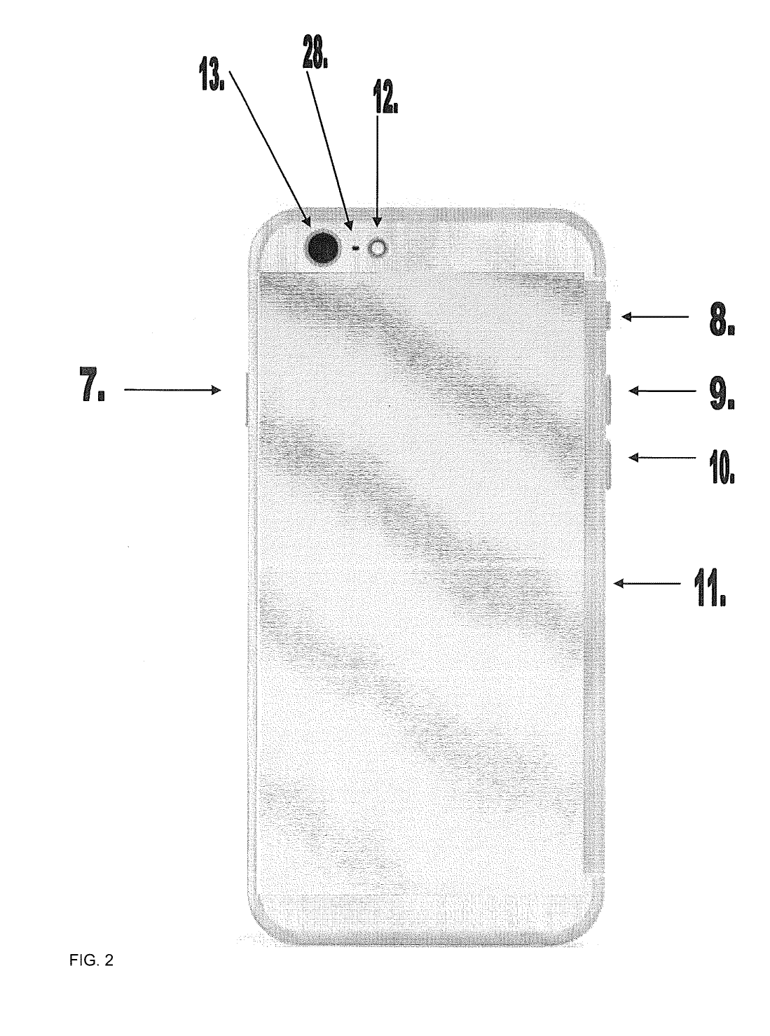

FIG. 2 shows a rear view of the exemplary mobile security monitoring device with SIM card slot 11, Back Facing Flash 12 and Back Facing Camera 13. The device also includes Audio of Incident 28.

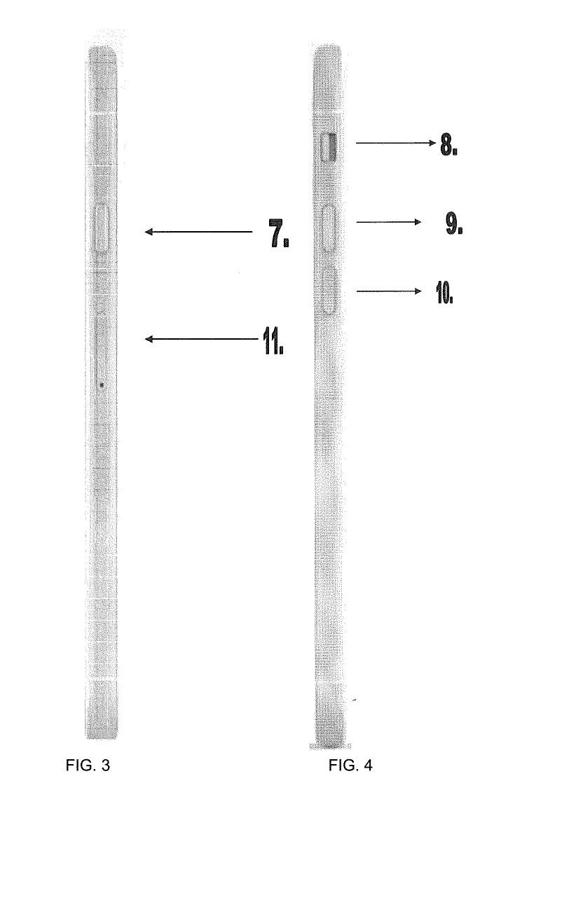

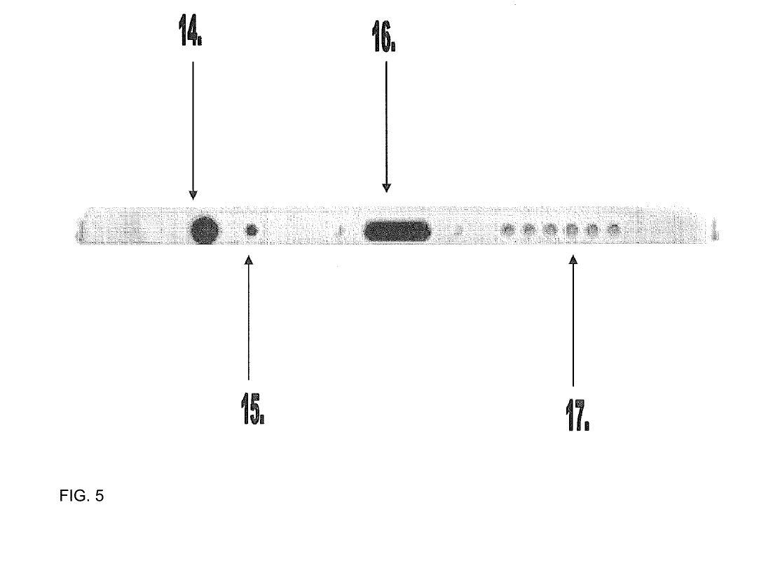

FIGS. 3-4 show side views of the exemplary mobile security monitoring device, while FIG. 5 shows a bottom view of the device.

In one implementation, the security monitoring device of FIGS. 1-12 perform the following:

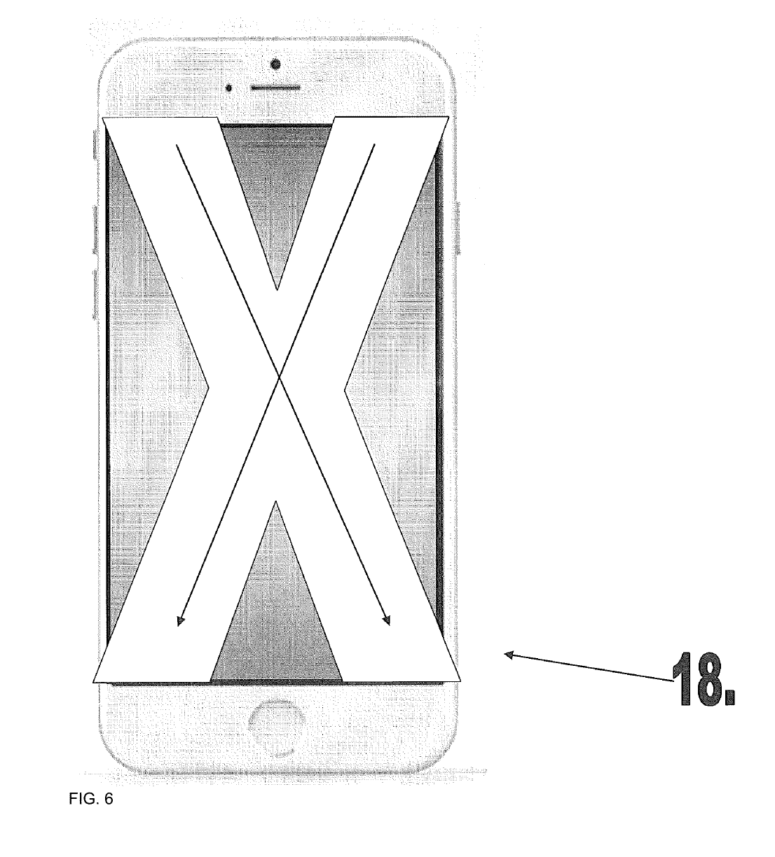

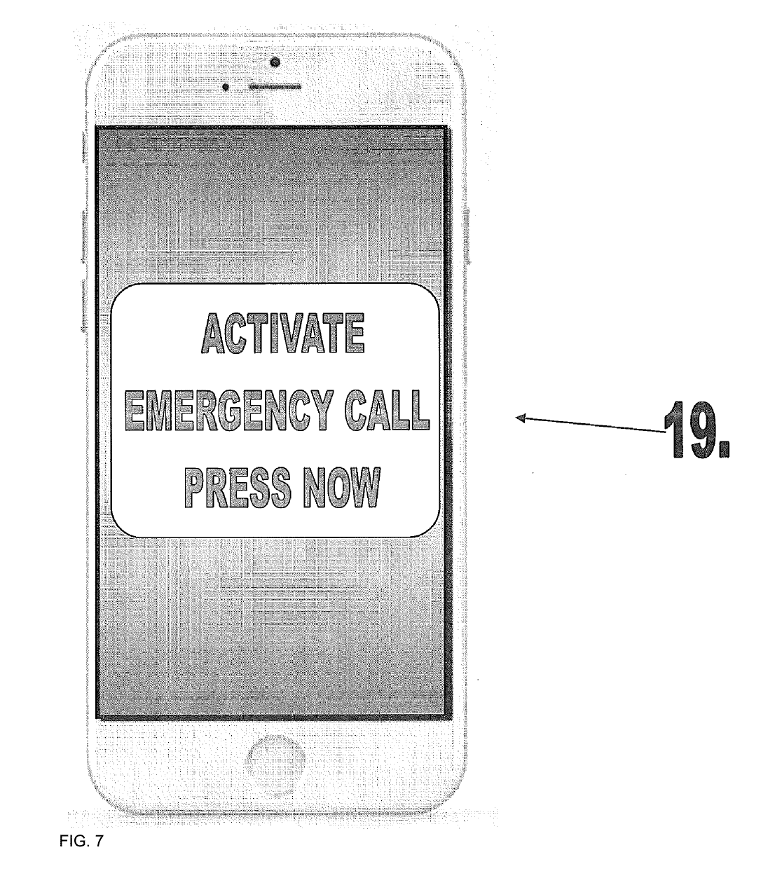

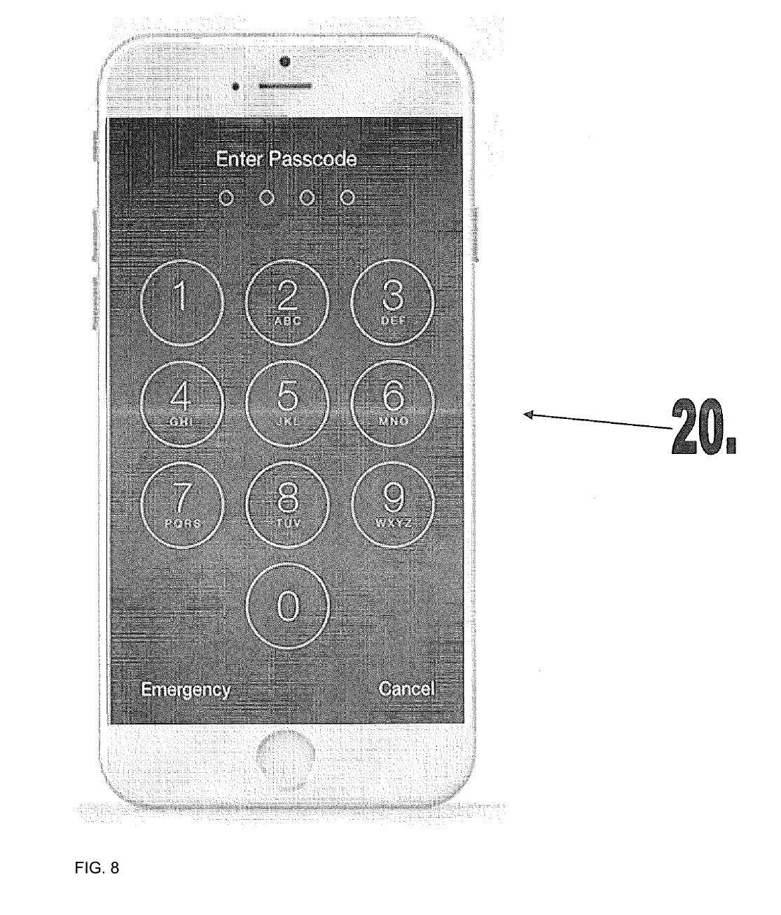

1. Initiation of the App
This can be achieved utilizing many of the keys on the device. Each device must be designed independently due to the various designs of smartphones on the market, and there are a number of ways a user can activate the app:
   One method is to press a button to cause the phone to come to life followed by a corner to corner swipe of the touch screen FIG. 1 (5), creating an “X” pattern FIG. 6 (18). “Alternatively the application may prompt the user to make their own swipe on the phone of their choosing at the initial setup of the application to prevent accidental activation. The swipe pattern may be displayed on the lock screen of the phone as a transparent outline for the user to trace on the lock screen if in fact they are in an emergency. Then followed by an indicator that must be pressed to initiate emergency app deployment confirmation FIG. 7 (19).
   Another method is to utilize the Volume Up Button FIG. 1 (9), Volume Down Button FIG. 1 (10), the Camera Button FIG. 2 (7) or the Power button FIG. 1 (7) and define a particular sequence that must be pushed to initiate the app, followed by an indicator that must be pressed to initiate emergency app deployment confirmation FIG. 7 (19) . . . .
   To initiate in-pocket activation, tap the home button FIG. 1 (6) five times or tapping the face FIG. 1 (5) of the smartphone in an unusual pattern to activate it.

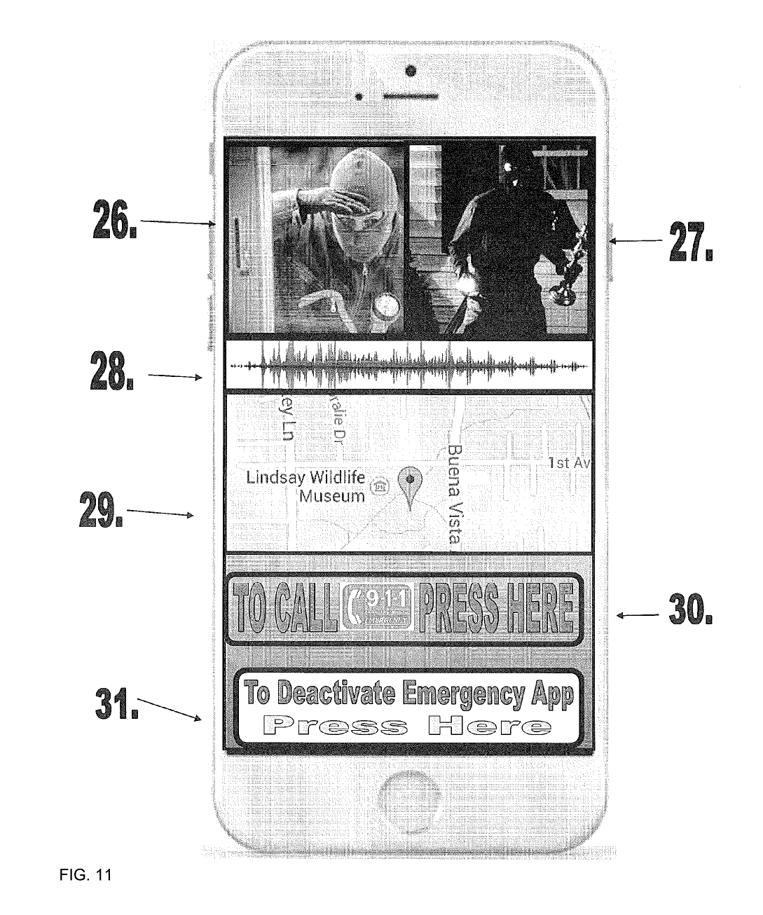

2. Once app has been deployed and initiated
Both the front camera FIG. 1 (4) and back camera FIG. 2 (13) are activated and both front images FIG. 11 (26) and back images FIG. 11 (27) are simultaneously recording.
The Microphones FIG. 5 (15) are activated, amplified, and recorded FIG. 11 (28).
GPS coordinates FIG. 11 (29) are collected.
Information from above is sent up to the cloud
All External Audio speakers FIG. 1 (3) and FIG. 5 (17) are disabled
If headphones are connected to the female jack FIG. 5 (14) or other Bluetooth headsets are connected . . . all these headphones will be disconnected. Only the Microphone FIG. 2 (28) and Bottom Microphone FIG. 5 (15) are activated.
Screen FIG. 1 (5) and all light FIG. 2 (12) emitting sources are disabled

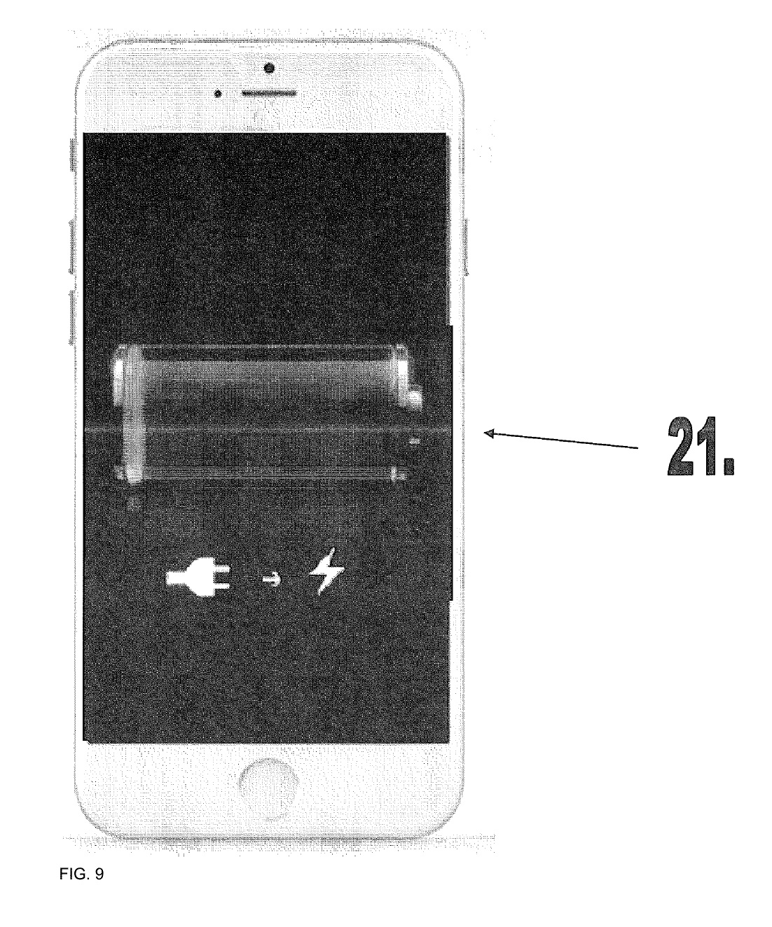

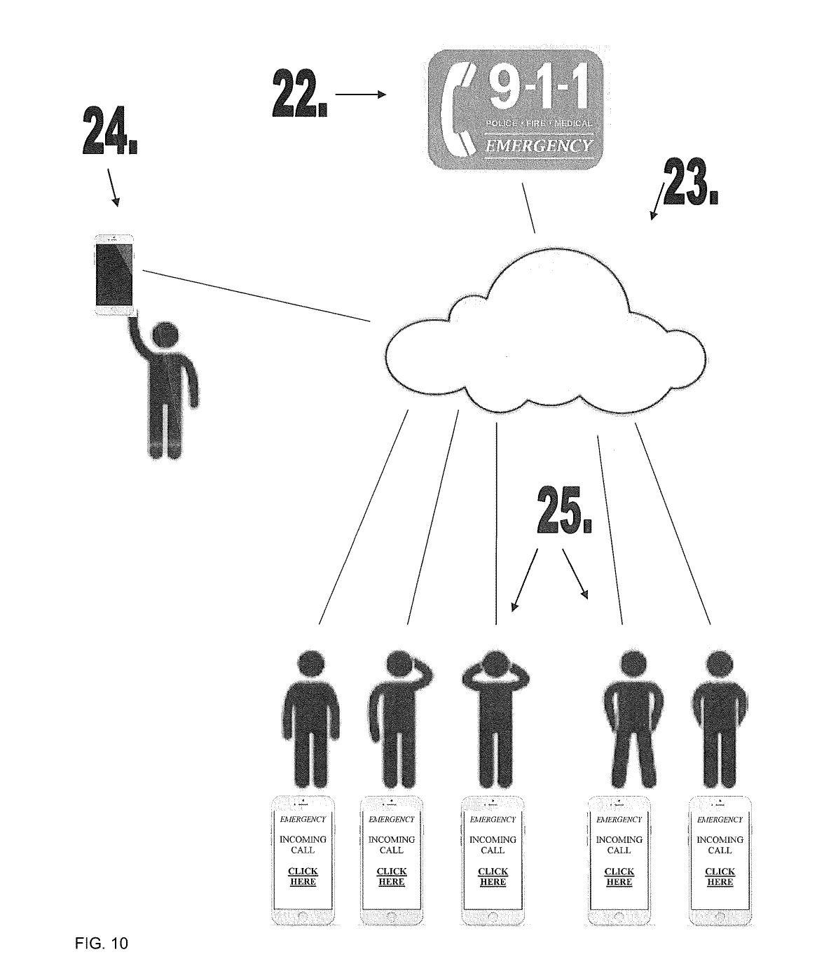

3. The Lock Code FIG. 8 (20)/Battery Indicator FIG. 9 (21) is displayed when phone is woken by perpetrator/attacker. This will prevent the perpetrator from knowing that the app has been activated.

4. Data Collected from FIG. 11 (26, 27, 28, 29) is constantly being uploaded to the cloud FIG. 10 (23). This information is stored for up to 30 days after the event. Once the app has been activated, a text message is immediately sent to all parties that were previously predetermined with a link to the cloud; the system will use a specific ring tone to alert these recipients of an impending emergency.
a. Once the circle member FIG. 10 (25) clicks on the link, they are shown the images, audio, and GPS location FIG. 11. There is also a prompt in which the receiver can choose to contact 9-1-1 with the information automatically by pressing a button FIG. 11 (30).
b. Unlocking method will utilize a series of MorseCode/passcode or swipe patterns that are sent to circle, once the recipient receives code, they can reply back with the unlock code or their predetermined swipe to disable the application, and return the phone to its normal settings
c. Contact Circle is a predetermined group of family and friends FIG. 10 (25) that are designated and can be altered at any time. Disablement/Security codes are also set up at the time when circle is created/altered.
d. Should the Contact Circle FIG. 10 (25) feel like any official intervention should be needed the Contact Circle will be able to select the option to contact authorities (9-1-1) with a single tap on the phone FIG. 11 (30). Once in contact with 9-1-1, The Contact Circle can describe the emergency situation with the 9-1-1 authorities, as well as accurately and calmly describing the situation that is taking place.

5. Upon receiving the information from (4) above from the cloud FIG. 10 (23), The Emergency response teams will be able to access full audio of the 9-1-1 call FIG. 11 (28), as well as a video stream of the incident taking place FIG. 11 (26,27) and a GPS map of where the emergency situation is taking place FIG. 11 (29). The 9-1-1 operator will be able to see an interface similar to FIG. 11.

6. Cloud Description—When an incident has occurred, all information collected from item FIG. 11 is stored for no more than thirty days of the incident. This cloud storage FIG. 10 (23) includes all Audio, Video and the sequence of pictures that were collected while the incident was taking place FIG. 11 (26, 27, 28, 29).

7. Application Disablement—After the incident has occurred, the app will run in the background of the phone while the phone itself is black or in a “dead phone state”. This creates the sense of a dead phone, where the phone will not respond to any of physical keys which include the Volume Up Button FIG. 1(9), Volume Down Button FIG. 1(10), the Camera Button FIG. 2(7), the Power Button FIG. 1 (7) or the Display/Touch Screen FIG. 1 (5).

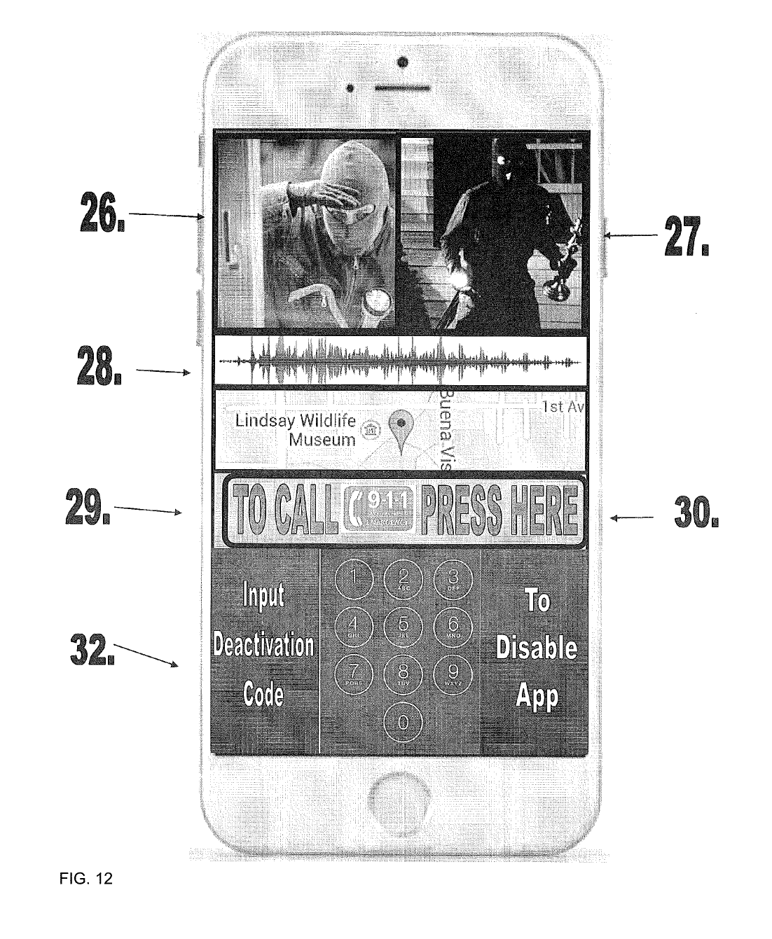

To restore a phone to its regular state, the Circle of Friends FIG. 10 (25) will be able to see on their phone an option in which they can tell the Savilife App that the danger has passed. This is done by one of the Circle members inputting the deactivation code in the Deactivation prompt FIG. 12 (32). Optionally, the user will be able to configure the application to use their own personalized swipe on the phone to set as the unlock code should they choose. Upon entry of the correct deactivation code, both phones will automatically exit the application and both phones will go back to their regular, non-emergency state. This feature, along with the pin code deactivation code is setup when the Application is first installed on the phone as an initial prompt

Upon pressing this button, the Circle of Friends acknowledges that the danger has passed and that the initiator's phone can go back to normal. The user has the option of having one, two or three friends to enter the code to ensure that the situation has passed. Having multiple friends in the circle ensures that if two or three friends are in the same situation together (i.e. husband and wife are in the same situation), or say if one user initiates the app, and the friend is forced to disable the application, having multiple users disable the app will present a failsafe from that happening.

Also, the application can optionally detect how many people are viewing the live stream of the incident occurring. So if only one person opened the incident report and only one person says it's safe, it can be assumed that the situation has passed and that the application can be disabled.

### REFERENCE NUMERALS

1. Smart Phone
2. Forward Facing Camera
3. Ear Receiver
4. Front Face Microphone
5. Display/Touch Screen
6. Home Button
7. Camera Button
8. Lock Switch
9. Volume up Button
10. Volume Down Button
11. SIM card slot
12. Back Facing Flash
13. Back Facing Camera
14. Headphone Jack
15. Bottom Microphone
16. Lightning Connector
17. Bottom Speaker
18. “X” Pattern on Screen
19. “Activate Emergency Call Press Now” Prompt Screen
20. Lock Code/Battery
21. Low Battery Indicator
22. 9-1-1 Contact
23. Cloud
24. User
25. Circle (of friends)
26. Front Side Camera
27. Back Side Camera
28. Audio of Incident
29. Location (GPS coordinates) of the incident.
30. Slide to Call 9-1-1
31. Deactivation of 9-1-1 Emergency App
32. Pin Code Prompt for Safety

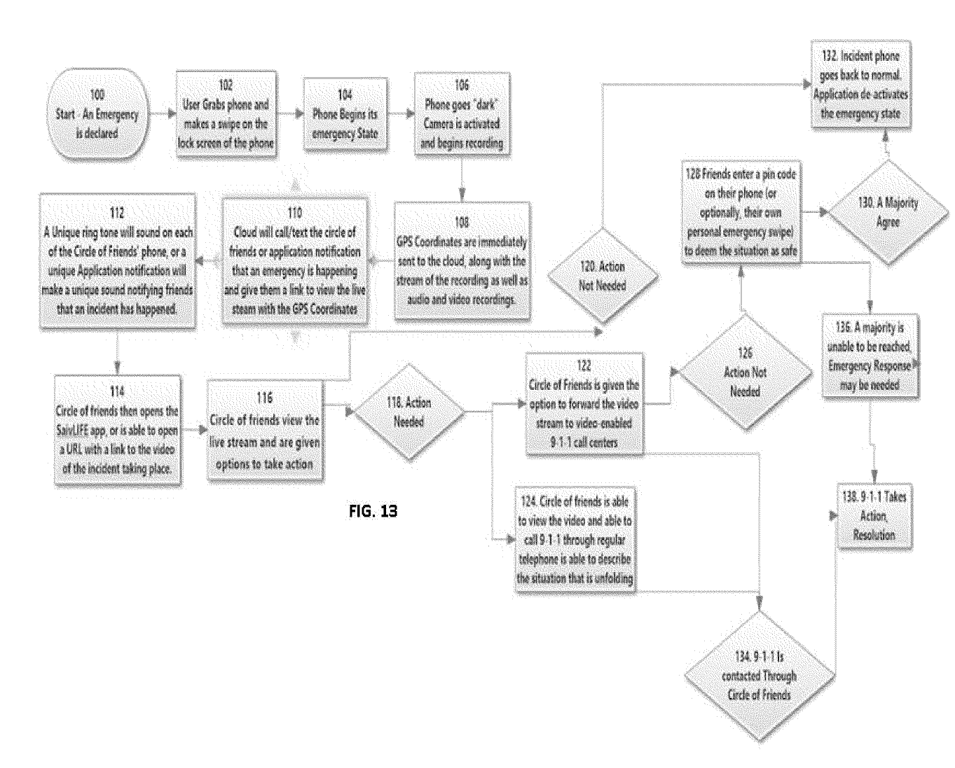

FIG. 13 shows an exemplary process executed by the monitoring device of FIG. 1. Turning now to FIG. 13, when an emergency occurs in which a user feels threatened or feels like outside help may be necessary, the user can use the application (called SaivLIFE) to call for help whenever they feel threatened. At the start of an emergency (100), there are couple of steps in which the user can take to augment the emergency situation.

In an emergency, the user can use their phone to call for help, when they feel like their friends can help, particularly if they cannot speak such as the cases of Bank Robberies, Home Break-ins, Held at Gunpoint, etc. In these cases, the user can use their phone (102) and make a swipe on the lock screen on the phone. This swipe will activate the application, causing the phone to begin its “emergency state.” (104)

When the phone enters its emergency state, there are various things that occur. First, the phone goes dark (106) in what is seen as a “dead phone state.” In this “dead phone state.” The first thing that occurs is that the phone goes “dark.” For the purposes of the application, a phone that goes “dark” can mean various things. “Dark” can mean that the entire screen is shut off, depending on the device, where it gives the feeling that the phone has been turned off. “Dark,” depending on the device, also can mean that there is something that is on the screen that is small and almost invisible to the naked eye, in the event the phone manufacturer does not allow the phone to go “Dark” due to restrictions of the device. This dark item can be a small, 1 pixel-large icon that is displayed on the first available pixel that is on either of the four corners of the phone. This 1 pixel image is small enough to not be seen by anyone who picks up the phone and wants to access the application.

In this dark state, the Power Buttons, the camera buttons, volume up and volume down buttons are then automatically disabled. If someone were to pick up the phone and press any of those buttons, there will be no response from the phone. Optionally, if anyone were to pick up the phone and press the power button, the phone application will display a “dead battery” icon, and quickly disappear as consistent with normal operation of the phone.

Once the phone goes “dark,” there are various things that immediately occur. The phone first makes a quick snapshot of the GPS coordinates and location of the phone. The phone then turns on both the microphone of the phone, as well as the front and/or back video cameras. The phone automatically sends the GPS coordinates to the cloud, and begins streaming either video or pictures to the cloud (108). The cloud will receive the GPS coordinates and the stream and process that data. The cloud will then look up the circle of friends' contact information that has been previously inputted by the user. The cloud will then either call or text the circle of friends in an alert that an emergency is happening (110). Optionally, the cloud will also give the circle of friends an application notification that has a detail of the event. The application notification can optionally bypass all toast notification settings, and it can send pop ups that cannot be ignored. Optionally, the application will utilize the lights on the phone, such as turning on the flashlight or any other external light of the receiver's phone and blinking a series of lights to grab the contact's attention (112). This includes, but not limited to blinking the receiver's main screen a series of times to attract the receiver's attention.

There are two things that can potentially happen. Once the receiver sees the application has been launched, and they view the stream of an incident that is happening, the receiver can either take action (118), or not take action (120).

Should the receiver(s) deem the situation is safe; the receiver(s) deem the event “do not take action” (120), and deem the situation as safe by inputting a predetermined pin code that the user has setup during the initial setup of the application. Optionally, this pin code can also be classified as the person's own personal swipe they have to launch the application on the lock screen (128). If there are several receivers on the call that are from the Circle of Five Friends, there optionally needs to be a majority of half of the receivers that agree that the situation is safe (130). When a majority of friends agree that the situation has become safe, the phone will then go back to normal and then de-activates the emergency state (132). Should a majority unable to make a consensus, there will be an option to forward the call to the police, 9-1-1 call center or any other equivalent call center that may be able to help the situation (136). In some 9-1-1 call centers that are able to receive video, the application will automatically forward the video of the incident that is taking place. When this happens, 9-1-1 or any equivalent call centers will be responsible to resolve the issue and the application has done its job (138). An example of equivalent call centers may involve School Police, tech center police, Rapid Transit Police and other, but not limited to, other private police centers.

Should the receiver(s) deem the situation as not safe; the receiver(s) deem the event “Action needed” (118). There are several things that can happen in this case depending on the situation. The receiver has a direct option to deem the situation as “not safe” and can give the situation over to the police directly, including forwarding the video stream to any video-enabled 9-1-1 call center (122). Should the 9-1-1 call center be video enabled, the 9-1-1 call center can then receive the information from the circle of friends (134) and the 9-1-1 center will be able to take the appropriate response (138). If action is not needed and the incident resolves itself without the intervention of the police of the circle of friends (126), then the receivers then will be able to enter their pin number in the same process as the “do not take action” process, where they deem the situation as safe by inputting their predetermined pin code that the user has setup during the initial setup of the application. The same series of events must be forwarded as mentioned in the paragraph above, where only when majority is met and everyone can agree that the person is safe, only then will the phone be returned to its original state (140).

However, if there are several calls that are within the same area, it may be that the case that a community events is happening such as a school shooting, a fire, a hostage situation or some other event that may be occurring. Because of this, the system may recognize a large amount of calls in the same area due to the proximity of the calls. If this were the case, it could be deemed that the system can declare the Community may be in Danger (142). If the system determines that this is to be the case, 9-1-1 or any other emergency operator can use their computers to determine the actual risks (i.e. a fire or a shooting) and take the appropriate action (144). If this were to occur, 9-1-1 will be able to send a notification through the application of the danger that is happening and gives all those who are in the vicinity or possibly heading towards that vicinity that an incident is taking place (144) If that is the situation that is unfolding, 9-1-1 can cautiously tell the community to avoid the area if possible. This way, the police will be able to give a quicker response and people will know to avoid the area, causing all potential bystanders to clear the area. It can also be an application to create a positive dialogue between the police and the community to announce any potential incidents that are taking place as they are unfolding (148).

In the events for those who are in the area of a potential incident and have the SaivLIFE application, the phone is able to send out a loud alert of a situation that is unfolding, allowing those who have SaivLIFE feel like they have an extra blanket of security. Police/Fire departments can then use the application to take appropriate steps to solve the issue, including getting tips on an incident that is taking place even before they arrive on the scene. Or in the case of a fire, account for everyone that is in a fire and create an evacuation plan even before they arrive on the scene. (150). The application can send alerts via loud chimes or blinking lights via the SaivLIFE application, and the user has the ability to take the action. The Police and the community have an opportunity to work together in the situation at hand (152), and the police can take account of everybody that is effected by the potential incident (154).

The devices may be operable in association with the communications system, medium or network in accordance with an embodiment of the present invention. The communications system, medium or network may be a mobile, wireless, cellular communications system or similar system. The layout and design illustrated herein is for purposes of explaining the present invention and the present invention is not limited to any particular design. While the device is a wireless communications device, the present invention may also be applicable to wired or hard wired communication devices and systems.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for security monitoring using a mobile device, comprising:
detecting an activation condition associated with an emergency; and
capturing and sending emergency data stream including images or video, audio, and positioning coordinates to a cloud-based processor to store and forward to a predetermined circle of family and friends to allow them to view the stream of audio, images/video and positioning coordinates in real time.

2. The method of claim 1, comprising sending the predetermined circle an access link via text or an application notification via a phone's toast notification using a unique ringtone or a unique application notification sound.

3. The device method of claim 1, comprising sending a text or calling an emergency number in a situation where an emergency is occurring.

4. The method of claim 3, wherein the emergency number comprises a local police number or 911.

5. The method of claim 1, comprising a silent operation code to turn off all audio output and light from the device while streaming the data to the cloud and the circle.

6. The method of claim 1, comprising a silent operation code to turn off all audio output and light from the device while streaming the data to the circle or the police.

7. The method of claim 1, comprising code to recognize a predetermined sequence before entering an activation condition.

8. The method of claim 7, comprising forming an X pattern or a user predefined swipe as indicated by the user during the initial setup of the application on a display followed by an indicator to be pressed for emergency confirmation.

9. The method of claim 1, comprising capturing images or videos from a front and a rear camera.

10. The method of claim 1, comprising capturing and amplifying audio from a microphone.

11. The method of claim 1, comprising disabling external speakers or headsets coupled to the mobile device.

12. The method of claim 1, comprising displaying a lock code or a black screen/dead battery icon on the mobile device when an unauthorized user accesses the phone.

13. The method of claim 1, comprising rendering a predetermined ring tone to alert recipients of an impending emergency.

14. The method of claim 1, comprising unlocking the mobile device from the activation condition using a series of MorseCode/passcode sent to the circle, and once a recipient receives the code, the recipient replies with the unlock code to return the mobile device to its normal settings.

15. A mobile device, comprising
a processor wirelessly coupled to a cloud;
a camera coupled to the processor;
a positioning system coupled to the processor; and
code executed by the processor to detect an activation condition and to capture and send emergency data stream including images or video, audio, and positioning coordinates to the cloud and then to a predetermined circle of family and friends to allow them to view the stream of audio, images/video and positioning coordinates in real time.
The device of claim 11, comprising The device of claim 11, comprising sending a text or calling an emergency number in a situation where an emergency is occurring.

16. The device of claim 13, wherein the emergency number comprises a local police number or 911.

17. The device of claim 11, comprising a silent operation code to turn off all audio output and light from the device while streaming the data to the cloud and the circle.

18. The device of claim 11, comprising a silent operation code to turn off all audio output and light from the device while streaming the data to the circle or the police.

19. A system, comprising:
a cloud;
a processor and data storage device coupled to the cloud;
one or more mobile devices wirelessly coupled to the cloud, comprising:
a processor wirelessly coupled to a cloud;
a camera coupled to the processor;
a positioning system coupled to the processor; and
code executed by the processor to detect an activation condition and to capture and send emergency data stream including images or video, audio, and positioning coordinates to the cloud and then to a predetermined circle of family and friends to allow them to view the stream of audio, images/video and positioning coordinates in real time, and code to send the predetermined circle an access link via text during the activation condition.

20. The method of claim 19, compromising a slider for emergency display that is present on a lock screen that is either transparent, or easy to see to show that the code is active and is launchable on the lock screen.

21. The method of claim 19, comprising an active screen with a picture of one pixel on the screen which is hard for an unauthorized user to see when glancing on the mobile device.
